(19) United States
(12) Patent Application Publication
(10) Pub. No.: US 2022/0018701 A1
(43) Pub. Date: Jan. 20, 2022

(54) MEASURING PROBE FOR DETERMINING OR MONITORING A PHYSICAL OR CHEMICAL PROCESS VARIABLE OF A MEDIUM

(71) Applicant: Endress+Hauser SE+Co. KG, Maulburg (DE)

(72) Inventor: Dirk Osswald, Schopfheim (DE)

(21) Appl. No.: 17/295,164

(22) PCT Filed: Oct. 31, 2019
(86) PCT No.: PCT/EP2019/079877

§ 371 Date: May 19, 2021

(30) Foreign Application Priority Data
Nov. 21, 2018 (DE) 10 2018 129 357.7

(51) Int. Cl. G01F 23/284; H01Q 1/22

(52) U.S. Cl. CPC G01F 23/284; H01Q 1/225

(57) ABSTRACT

A measuring probe for determining or monitoring a physical or chemical process variable of a medium in a container includes: a tubular housing component for receiving at least one measuring element sensitive to the process variable; a process adapter in an end region of the housing component as to be screwed into a process connection of the container by a screw thread; a housing adapter for fastening measurement electronics housing in the opposite end region of the housing component; between the process adapter and the housing adapter, an exterior wall of the housing component defining an exterior contour configured such that a torque can be applied to the housing component via the exterior contour to screw the process adapter into or out of the process connection; and parallel cooling fins formed in the exterior contour.

The invention relates to a measuring probe for determining or monitoring a physical or chemical process variable of a medium, which is in a container. The container may be a tank, a pipeline, or the like.

For example, fill level measuring devices, flow measuring devices, pressure and temperature measuring devices, analysis measuring devices, etc. are used for detecting process variables in automation technology. The measuring devices detect the corresponding process variables of fill level, flow rate, pressure, temperature, analysis data, such as pH value, turbidity, or conductivity. Measuring devices essentially consist of a measuring probe, with at least one sensor element or one measuring element, which supplies information about the process variable, and at least one electronics unit, which controls the sensor element, prepares and/or evaluates the information supplied by the sensor element/measuring probe, and provides measured values of the process variable. The measuring probe described in the present patent application is to be understood in the above-described scope. Of course, it also applies to process variables of automation technology which are not explicitly mentioned here.

In the industrial field, measuring devices are frequently used in a process environment, the temperature of which is above the maximum permissible temperature of temperature-sensitive components or temperature-sensitive parts of the electronics unit, the so-called measuring transducer. In order to prevent a temperature-sensitive component or a temperature-sensitive part from being destroyed—which usually leads to failure of the measuring device—a connecting component whose thermal resistance is high enough that the sensor element/measuring probe and the electronics unit are thermally decoupled from each other to the required degree is provided, for example, between the measuring probe, which is exposed to the process, and the electronics unit with the at least one temperature-sensitive part. A corresponding device for determining the fill level of a filler in a container has become known, for example, from DE 10 2012 103 493 A1.

Furthermore, it should be noted that measuring devices are often subjected to temperature changes in rapid succession when they are used in the chemical or pharmaceutical industry, and also in the food sector, for example, on account of cleaning processes. High temperature gradients occur at least briefly as a result of rapid temperature changes. These temperature gradients subside only after the thermal equilibrium between the measuring device and the process is reached.

Due to the different boundary conditions, such as required compressive strength and/or electrical conductivity, it is advisable in industrial applications to produce the thermally decoupled connecting component from a material which has the properties of metal with regard to stability and conductivity. However, the usually high thermal conductivity of metals principally runs counter to a desired thermal decoupling. It is conceivable to achieve a high thermal resistance and thus good thermal decoupling by adapting the geometry of the connecting component. Especially, a desired high thermal resistance can be realized by a suitable reduction in cross-section and/or a suitable increase in the length of the connecting component.

A disadvantage of these solutions is that a compact design of a measuring device can hardly be achieved if a connecting component with increased longitudinal expansion is used for thermal decoupling. Cross-sectional reduction is also not possible as desired because the stability required at the industrial point of use of the measuring device is no longer guaranteed below a predetermined cross-section of the connecting component.

The invention is based on the object of proposing a compact measuring probe, suitable for temperature reduction, for determining a physical or chemical process variable in automation technology.

The object is achieved by a measuring probe for determining or monitoring a physical or chemical process variable of a medium, which is in a container, wherein a tubular housing component is provided for receiving at least one measuring element sensitive to the process variable, wherein a process adapter is provided in an end region of the tubular housing component, which process adapter can be screwed into a process connection part of the container by means of a screw thread, wherein a housing adapter for fastening the measurement electronics housing is provided in the opposite end region of the tubular housing component, wherein in an intermediate region between the process adapter and the housing adapter, the exterior wall of the tubular component has a defined exterior contour, which is designed in such a way that a torque can be applied to the tubular component via the defined exterior contour in order to screw the process adapter into or out of the process connection part of the container, and wherein parallel cooling fins, for example, arranged over the entire periphery, are formed in the exterior contour.

According to the invention, no change in the design of the measuring probe is thus required. Rather, the housing region provided and used for screwing in and unscrewing the measuring probe is additionally provided with cooling fins. These cooling fins are designed and dimensioned in such a way that neither the stability of the measuring probe nor the functionality of the housing region provided for the screwing-in and unscrewing process is impaired. According to the invention, a compact measuring probe is provided which additionally performs the function of inducing a temperature difference between the process in which the measuring probe is located and the temperature-sensitive electronics unit by inserting cooling fins which impede the heat transport.

An advantageous development of the measuring probe according to the invention proposes designing the defined exterior contour in such a way that it has an engagement surface for engaging a tool for screwing in or unscrewing the measuring probe from the process connection part. The defined exterior contour is preferably designed as an n-edge drive, for example, as a hexagonal drive. In industrial applications, process adapters with ¾″ and 1½″ process threads are widely used.

In addition to the surfaces with edges for engaging a tool, it is furthermore proposed that the defined exterior contour has a substantially round cross-section. In this embodiment, at least one radial bore is provided, for example or preferably, in the region of the defined exterior contour, via which bore a torque can be transmitted to the measuring probe by means of a suitable tool.

Furthermore, in conjunction with the solution according to the invention, it is proposed that the cooling fins are generated by grooves introduced into the defined exterior contour. These grooves preferably run over the entire periphery of the defined exterior contour. The penetration depth of the individual grooves depends on the defined exterior contour: While the penetration depth is the same over the periphery in the case of an exterior contour with a substantially round cross-section, it can be different over the periphery in the case of an exterior contour with edges. Here, the penetration depth in the region of the edges is greater than in the region of the straight surfaces. In any case, care must be taken to ensure that the penetration depth in the region of the strongest reduction in diameter is dimensioned such that sufficient stability of the measuring probe is still ensured. The penetration depth is in the range of a few millimeters, for example, in the case of a process adapter with a ¾″ process thread, between 4-7 mm. A groove between two adjacent cooling fins, for example, has a semicircular or a rectangular, trapezoidal, or triangular cross-section with preferably rounded corners.

The spacing between two adjacent cooling fins is, for example, in the range of 1-2 mm. Here, too, care must be taken to ensure that the remaining stability is sufficient to ensure that no deformations occur in the region of the exterior contour when force is introduced by engaging a tool.

The grooves for creating the cooling fins are, for example, introduced into the exterior contour by means of a lathe and a recessing tool. Alternatively, a milling process can be used. If the tubular housing component is produced as a cast part, the cooling fins and grooves are already reproduced in the tool under certain circumstances.

The measuring probe is preferably made of stainless steel. Other suitable materials are, for example, aluminum, normal steel, alloy, or titanium.

The invention is explained in greater detail with reference to the following figures. The following is shown:

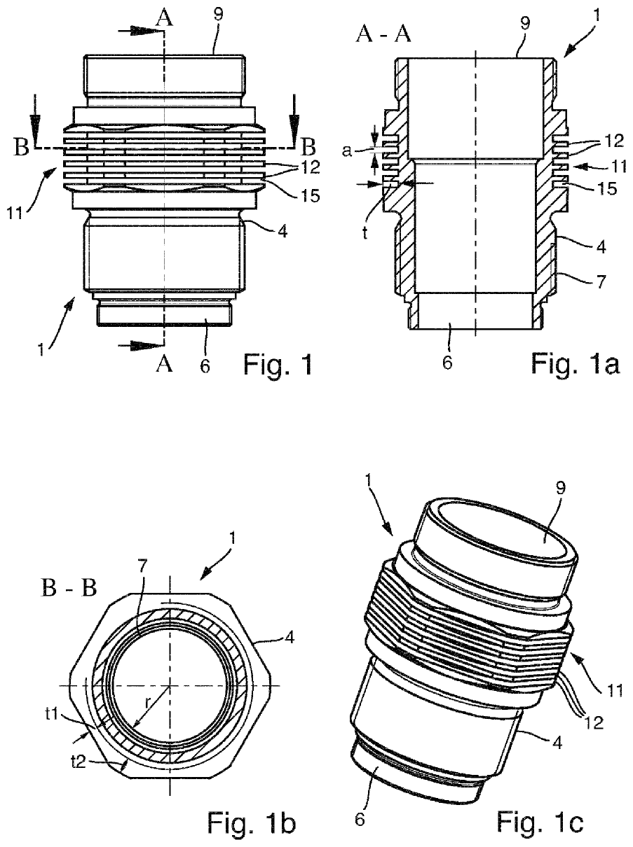

FIG. 1: a measuring probe according to the invention with a 1½″ process thread in side view;

FIG. 1a: a longitudinal section through the measuring probe shown in FIG. 1 according to the designation A-A;

FIG. 1b: a cross-section through the measuring probe shown in FIG. 1 according to the designation B-B;

FIG. 1c: a perspective view of the measuring probe shown in FIG. 1;

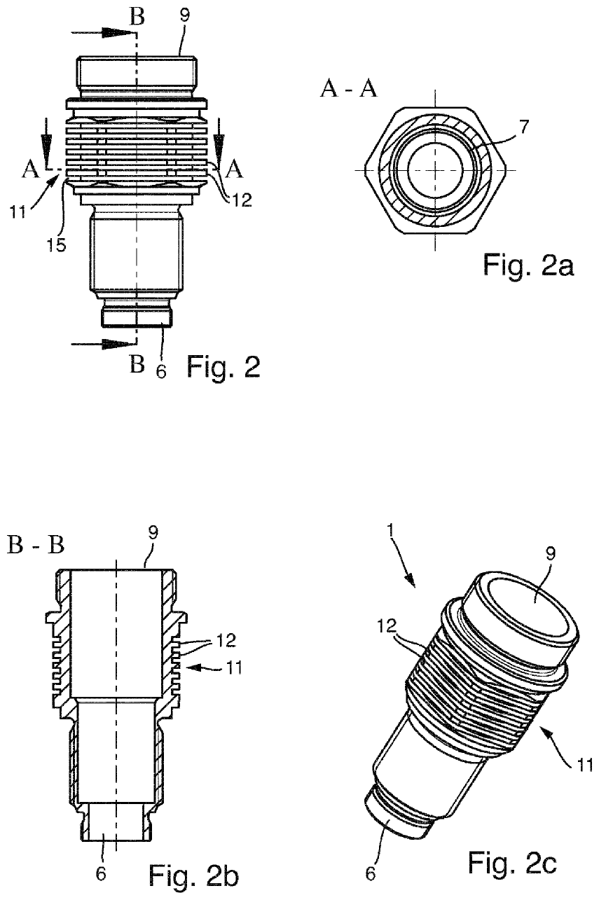

FIG. 2: a measuring probe according to the invention with a ¾″ process thread in side view;

FIG. 2a: a cross-section through the measuring probe shown in FIG. 2 according to the designation A-A;

FIG. 2b: a longitudinal section through the measuring probe shown in FIG. 2 according to the designation B-B;

FIG. 2c: a perspective view of the measuring probe shown in FIG. 2; and

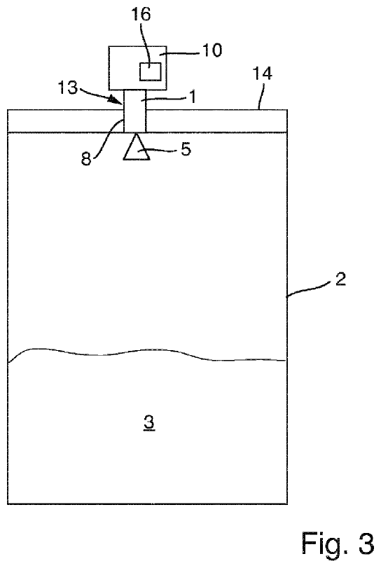

FIG. 3: a schematic representation of a measuring device which is fastened to a container via the measuring probe according to the invention.

FIG. 1 shows a measuring probe 1 according to the invention in a side view, in this case with a 1½″ process adapter 6. The measuring probe 1 has a tubular housing component 4 for receiving at least one measuring element 5 sensitive to the process variable. The measuring element is not shown separately in FIG. 1. As already mentioned above, it is designed in such a way that it supplies information about the process variable to be determined or monitored. FIG. 3 shows, for example, a radar fill level measuring device. The measuring element 5 in this case is the antenna which emits and receives the measuring signals. In the case of a TDR fill level measuring device, the measuring element 5 is a conductive elongated probe which extends into the container 2.

Referring to FIG. 1, a process adapter 6 is provided in an end region of the tubular housing component 4, which process adapter can be screwed by means of a screw thread 7 into a corresponding thread of a process connection part 8 of the container 2. As can be seen in FIG. 3, the process connection part 8 may be located in an opening 13 in the lid 14 of the container 2. Of course, the process connection part 8 may also be arranged in the side wall of the container 2. This is usually the case with pressure measuring devices or limit level measuring devices.

A housing adapter 9 for fastening the measurement electronics housing 10 is provided in the opposite end region of the tubular housing component 4. A screw connection is usually also provided here. The connection for receiving the measurement electronics housing 10 can furthermore be embodied as a welded connection, with or without a screw thread. In addition, it can also be a plugged connection which is secured, for example, with a snap ring. Of course, the aforementioned connection techniques can also be combined with one another. In the intermediate region between the process adapter 6 and the housing adapter 9, the exterior wall of the tubular component 4 has a defined exterior contour 11. This exterior contour 11 is designed such that it can be used to apply a torque to the tubular component 4 in order to screw the process adapter 6 into or unscrew the process adapter 6 from the process connection part 8 of the container 2.

According to the invention, parallel cooling fins 12 or grooves 15, preferably arranged over the entire periphery, are introduced into the exterior contour 11. The grooves 15 reduce the cross-section of the tubular component in the region of the defined exterior contour. The grooves 15 or cooling fins 12 prevent the temperature prevailing in the container 2 from not being forwarded unrestrictedly to the temperature-sensitive measuring electronics 16. Rather, as a result of the reduction in the diameter of the measuring probe 1 in the intermediate region, the grooves 15 lead to an increase in the thermal resistance and thus to a temperature drop of a few degrees Celsius.

In the longitudinal section of FIG. 1a and the cross-section of FIG. 1b, the penetration depth t of the grooves 15 between the cooling fins 12 as well as the spacing a between two adjacent cooling fins 12 are shown. Both of these variables are dimensioned in such a way that the required and necessary stability of the measuring probe 1 is still ensured. It can be seen in the cross-section in FIG. 1b that the penetration depth t of the grooves 15 can vary over the periphery of the defined exterior contour 11. The penetration depth t ends on a circular line with the radius r. The penetration depth t2 in the case of an n-edge drive in the region of the corners is thus greater than the penetration depth t1 in the region of the straight sections t1.

Since the measuring probe 1 shown in FIGS. 2, 2a, 2b, and 2c differs from that in the corresponding FIG. 1 only by the dimensioning, repetition of the description is omitted.

### LIST OF REFERENCE SIGNS

1 Measuring probe
2 Container
3 Medium
4 Tubular housing component
5 Measuring element
6 Process adapter
7 Screw thread
8 Process connection part
9 Housing adapter
10 Measurement electronics housing
11 Exterior contour
12 Cooling fin
13 Opening
14 Lid
15 Groove
16 Measuring electronics

1-10. (canceled)

11. A measuring probe for determining or monitoring a physical or chemical process variable of a medium in a container, the probe comprising:
at least one measuring element configured to be sensitive to the process variable;
a tubular housing component configured to receiving the at least one measuring element, wherein the housing component includes:
a process adapter in a first end region of the housing component, the process adapter configured to be screwed into a process connection of the container via a screw thread; and
a housing adapter in a second end region of the housing component opposite the process adapter, the housing adapter configured to fasten a measurement electronics housing to the housing component,
wherein, in an intermediate region between the process adapter and the housing adapter, an exterior wall of the housing component defines an exterior contour that is configured to enable a torque to be applied to the housing component via the exterior contour as to facilitate screwing the process adapter into or unscrewing the process adapter from the process connection of the container, and
wherein parallel cooling fins extend from the exterior contour in the intermediate region.

12. The measuring probe of claim 11, wherein the exterior contour includes an engagement surface configured for engaging a tool for screwing the measuring probe into or unscrewing the measuring probe from the process connection of the container.

13. The measuring probe of claim 11, wherein the exterior contour is configured as an n-edge drive.

14. The measuring probe of claim 13, wherein the n-edge drive is a hexagonal drive.

15. The measuring probe of claim 11, wherein the exterior contour has a substantially round cross-section.

16. The measuring probe of claim 11, wherein in the area of the exterior contour, at least one radial bore is provided via which a torque can be transmitted to the measuring probe using a suitable tool.

17. The measuring probe of claim 11, wherein the cooling fins are arranged over an entire periphery of the exterior contour.

18. The measuring probe of claim 11, wherein a penetration depth of the cooling fins is dependent on the exterior contour and is between 4 and 7 millimeters (mm).

19. The measuring probe of claim 11, wherein a spacing between adjacent cooling fins is in a range between 1 and 2 mm.

20. The measuring probe of claim 11, wherein a recessed area between adjacent cooling fins has a semicircular, rectangular, trapezoidal or triangular cross-section.

21. The measuring probe of claim 20, wherein the recessed area between adjacent cooling fins has rounded corners.

22. The measuring probe of claim 11, wherein the measuring probe is made of stainless steel, aluminum, carbon steel, alloy, or titanium.
